(19) United States
(12) Patent Application Publication
(10) Pub. No.: US 2005/0153268 A1
(43) Pub. Date: Jul. 14, 2005

(54) Brain-based processing skill enhancement

(76) Inventors: William H. Junkin, Corona del Mar, CA (US); William D. Harrison, Laguna Niguel, CA (US)

Correspondence Address: PILLSBURY WINTHROP SHAW PITTMAN, LLP, P.O. BOX 10500, MCLEAN, VA, 22102, US

(21) Appl. No.: 10/756,284

(22) Filed: Jan. 14, 2004

(51) Int. Cl. G09B 19/00

(52) U.S. Cl. 434/321

(57) ABSTRACT

Skill enhancement tool for assessing and improving an individual's performance in multiple domains including processing of complex audio, visual and tactile perceptual inputs, operation of complex controls via manipulation, enacting complex motor sequences and complex cognitive tasks. The invention presents complex stimuli to an individual, monitors his or her reactions to the stimuli, and, in response to the user's reactions, changes the future stimuli to be presented in such a way as to alter the user's brain entrainment patterns to elicit improvement.

### BACKGROUND

The inventions described and claimed in this patent document relate to the assessment and enhancement of an individual's performance skills. The inventions provide apparatus and methods for assessing and improving an individual's performance in general and improving the individual's ability to perform a particular task. In general, this is accomplished by presenting complex stimuli to the individual, measuring the individuals reactions to that stimuli and then presenting additional stimuli that may be altered from the initial stimuli based on the individual's reactions to the previous stimuli. The performance skills to be measured and enhanced include motor, perceptual and cognitive skills. The stimuli are provided in a manner to induce brain activity balances that optimize the an individual's ability to perform a range of skills or a particular task.

In one respect, the inventions described herein can be thought of as a skill enhancement tool for assessing and improving an individual's performance in multiple domains including processing of complex audio, visual and tactile perceptual inputs, operation of complex controls via manipulation, enacting complex motor sequences and complex cognitive tasks. Complex stimuli are presented to an individual, the reactions of the individual are monitored, and, in response to the user's reactions, further stimuli are presented to the individual in such a way as to alter the user's brain entrainment patterns to elicit improvement.

As humans enter different mental and behavioral states (e.g., sleep, alertness, relaxation, mental focus), their brain waves are characterized by particular electroencephalographic (EEG) patterns. These patterns comprise different frequencies or mixtures of frequencies which occur at different strengths and in various mixtures in different regions of the brain. These EEG patterns have been extensively documented in controlled experiments published in the scientific literature. Some examples include, but are not limited to:

dominance of delta waves (˜1-4 Hz) during sleep

dominance of theta waves (˜4-8 Hz) during concentrated attention on mental tasks

dominance of alpha waves (˜8-12 Hz) during relaxation

dominance of beta waves (˜12-30 Hz) during active states

strongest activity in left orbitofrontal cortical region during positive emotional affect.

Differential performance with respect to a range of perceptual, attentional, and motor tasks has been shown to be strongly correlated with and influenced by the relative balance of brain activity in different regions. Inducing particular balances of regional brain activity patterns can induce improved performance with respect to these perceptual, attentional and motor tasks.

Examples include, but are not limited to:

Increases in beta frequency have been associated with facilitation of human performance on memory-related tasks (Kennerly).

Changes in the balance of alpha and beta frequencies have been associated with improved reading ability (Joyce).

Increases in beta activity have been associated with improved affect and/or decreased affective disorder (Berg & Siever).

Complex audio-visual entrainment has been associated with improvement in measures of chronic pain (Twittey & Siever).

Much has been learned in recent years about the brain events that underlie, and constitute the basis of, mental changes. Via brain activity measurement means, such as EEG, ERP, PET, fMRI, and SQUID, information has been collected about brain pattern changes correlated with ability to perform various tasks, attention, memory storage, memory retrieval, and related variables. These correlations have informed applications efforts, enabling the design of methods and devices by which individuals can determine their mental state and, in some cases, alter it.

As just one of many possible illustrative instances, self-test devices are being designed by the National Space Biomedical Research Institute (NSBRI), a NASA-funded consortium that studies health issues associated with space flight. One such self-test device is a hand-held device that performs a battery of specific tests to measure an individuals cognitive function. Such self-test devices can help to determine the effects of lack of sleep, exercise, hormonal balances, and dietary factors on cognitive function. The device performs nine tests that each take about two minutes to run. The tests can be run separately rather than as a complete battery if desired. During design of the self-test device, scientists ran candidate tests on people and measured various behavioral, cognitive, and brain wave patterns to identify those that were closely correlated with the outcomes of specific candidate tests. The scientists carefully identified which of the candidate tests were good predictors of the measures of interest (e.g., alertness, fatigue, working memory capacity, motor control). Those tests that turned out to be predictive were included among the nine tests performed by the device. Subjects can just take those nine tests (or subsets thereof) and determine, with reasonable accuracy, not just the specific outcomes of those particular tests, but the implications of the outcomes for the complex measures of interest. The system can be used by individuals from astronauts to truck drivers, to give them warning of whether they have the appropriate mental tools to enable them to perform whatever their upcoming task is, from a long drive to a space walk.

As another example, biofeedback methods have been used to help athletes enhance their performance. EEG brain wave patterns are monitored during performance (and even mental rehearsal) of particular actions (e.g., putting a golf ball). Specific overt EEG measures are used as indicators of “peak” versus sub-optimal mental effort. The level of power in particular frequency bands of the EEG, at particular locations in the brain, has been shown to correlate strongly with the level of accuracy in the action of interest (e.g., the putt). Similar effects have been shown in quite different fields, including the performance of musical pieces, performance on standardized tests, piloting a vehicle.

This methodology does not only provide an abstract indicator of the brain activity patterns associated with good performance. Having had the opportunity to observe those EEG patterns that correlated with good performance, practitioners have found ways to intentionally “induce” the EEG patterns that are associated with good performance. In such cases, it is typically the case that the individuals, having induced the key EEG patterns in their own brains, then were able to reliably perform a task at a higher success level than they could without this EEG training. In other words, the best performances of the task were accompanied by particular EEG patterns, and self-induction of those EEG patterns in individuals enabled them to improve their performance. This suggests that the EEG patterns themselves are at least partially causative agents of peak performances.

The ability of an individual to intentionally induce particular patterns of EEG activity at different brain locations therefore is of interest. Some individuals achieve a desired brain EEG state by internally “visualizing” certain settings, locations, or ideas. It is not known why such visualization may give rise to these patterns of EEGs. Others achieve desired EEG patterns by applying a combination of external stimuli, such as various sounds, images, or tactile patterns. It is not yet understood why certain patterns of external stimuli serve to induce particular localized EEG patterns.

### SUMMARY

The inventions described and claimed herein contemplate inducing of a balance of states in appropriate locations of the brain, without the use of EEG measures, via the known methodology of presentation of patterns of visual and auditory stimuli, so as to induce those brain state balances that correlate with improved performance at given tasks. In some embodiments of the inventions there is a ‘learning’ phase in which the system attempts multiple visual and/or auditory induction patterns, interleaved with testing of the subject on a particular task or tasks, enabling the system to generate or ‘learn’ sets of visual and/or auditory stimuli that turn out to give rise to improved performance. Using this approach, the system itself ‘learns,’ Contrast this learning with ‘feedback’ or ‘biofeedback’ systems in which it is the subject who learns to generate new responses in order to achieve a certain educed biological signal. In other embodiments of the inventions, systems that have already ‘learned’ are used to train an individual's performance.

There are at least two ways to improve through the use of our inventions: i) via training behavior (e.g., current challenging game software systems) and/or ii) via entraining or inducing complex patterns (or rhythms) directly in brain without overtly affecting behaviors (e.g., light-sound machines).

### BRIEF DESCRIPTION OF THE DRAWINGS

FIG. 1 describes one preferred embodiment of the inventions in which subjects are presented with stimuli and subjects are measured (e.g., speed, accuracy, blood pressure, affect), and selects subsequent stimuli to present based on whether their reaction performance has increased or decreased,

FIG. 2 describes a preferred embodiment in which the method of FIG. 1 is first used on multiple subjects, and the stimuli used for future subjects are selected on the basis of whether they occurred in the achievement of the most improvement in the past subjects.

FIG. 3 describes an embodiment in which the methods are applied to the specific measure of subjects' blood pressure.

FIG. 4 describes an embodiment in which the methods are applied to the specific measure of subjects' affect.

FIG. 5 describes an embodiment in which first multiple subjects are tested and then stimuli for presentation to subsequent subjects are selected on the basis of those stimuli which occurred in trials that led subjects to achieve criterion performance in the fewest trials.

FIG. 6 describes an embodiment in which first multiple subjects are tested and then stimuli for presentation to subsequent subjects are selected on the basis of which stimuli most often occurred in specific trials that immediately preceded measured improvement.

FIG. 7 describes an embodiment in which first multiple subjects are tested and then stimuli for presentation to subsequent subjects are not just selected from previous stimuli, but are created as new combinations of previous stimuli, based on those that most often occurred in specific trials that immediately preceded measured improvement.

### DETAILED DESCRIPTION

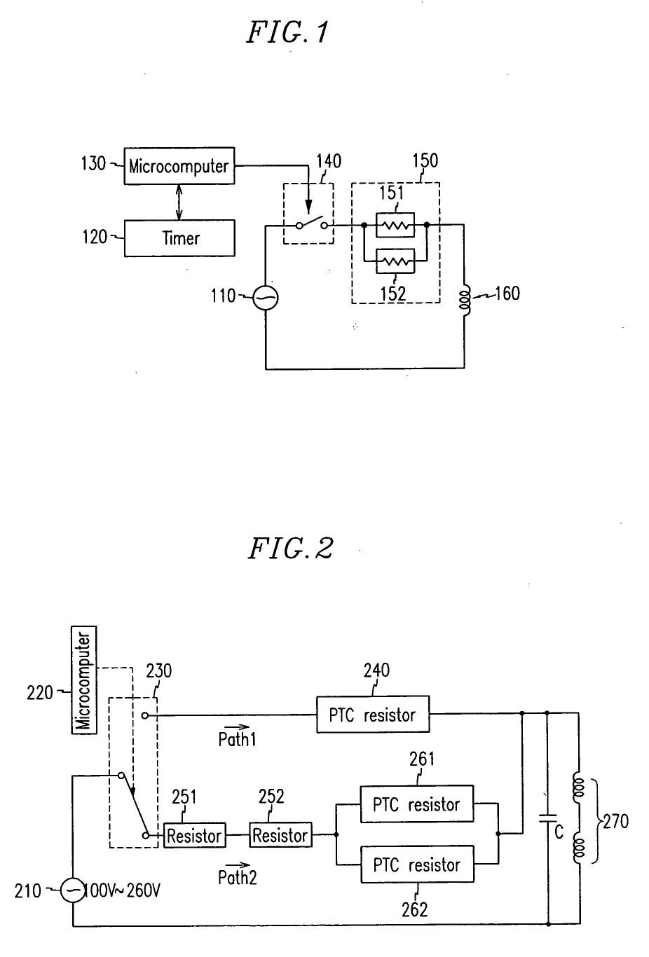

FIG. 1 is a flowchart describing some of the broad principles of the inventions. It describes one embodiment of the inventions in which subjects are presented with stimuli and subjects are measured (e.g., speed, accuracy, blood pressure, affect), and selects subsequent stimuli to present based on whether their reaction performance has increased or decreased, A human subject is tested at step 101 on some interactive task. The subject's performance (such as, for examples, speed, accuracy, etc.) is measured at step 102. After the subject's performance is measured, the subject is subjected, at step 103 to a first set of stimuli. The subject's performance is again measured at step 104. At step 105 it is determined whether the performance measured at step 104 is less than the performance measured previously. For the first set of stimuli the performance at step 104 would be compared to the performance at step 102. For later performance measurements at step 104, the comparison would be with previous performance levels measured at step 104.

If the performance measured at step 105 is less that the previous performance level, a new set of stimuli is selected at step 106. Depending on the type of performance being measured, step 106 can be a rather complex algorithm, examples of which are provided later. The newly selected stimuli are presented to the subject at step 103 and the subject's performance is measured again at step 104. Steps 103, 104, 105 and 106 form a continuous loop as long as the current performance is less than the previous performance.

If the performance measured at step 105 is not less that the previous performance level, the same stimuli are utilized at step 106 and again presented to the subject at step 103. The subject's performance is measured again at step 104. Steps 103, 104, 105 and 107 form a continuous loop as long as the current performance is not less than the previous performance.

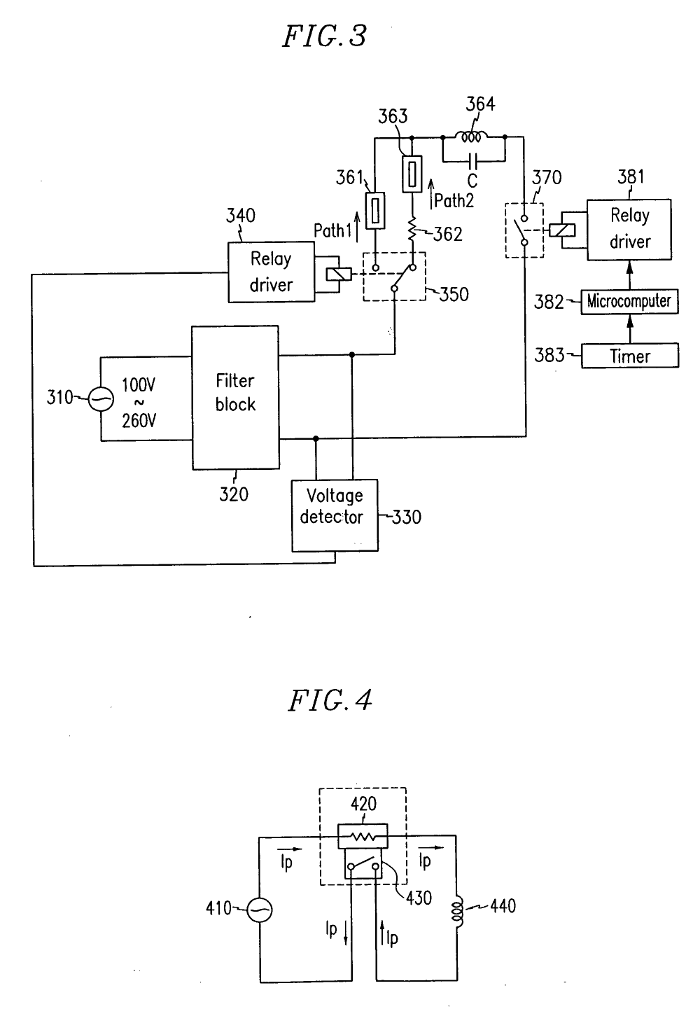

FIG. 2 is a flowchart describing an embodiment of the inventions in which multiple subjects are tested in order to identify in advance those stimuli and sequences of stimuli that are most useful for eliciting enhanced performance. The process begins at step 201 whereat multiple subjects are tested on the performance of a particular task.

Each subject at step 202 is subjected to stimuli in a looping fashion as described in FIG. 1. The subjects are relatively ranked at step 203 based on the highest level of performance achieved by each. It is noted which stimuli were utilized on the highest performing subjects and that stimuli is selected at step 204 for presentation to additional subjects at step 205. In this manner more useful stimuli can be presented, enabling future subjects to be enhanced with less trial and error.

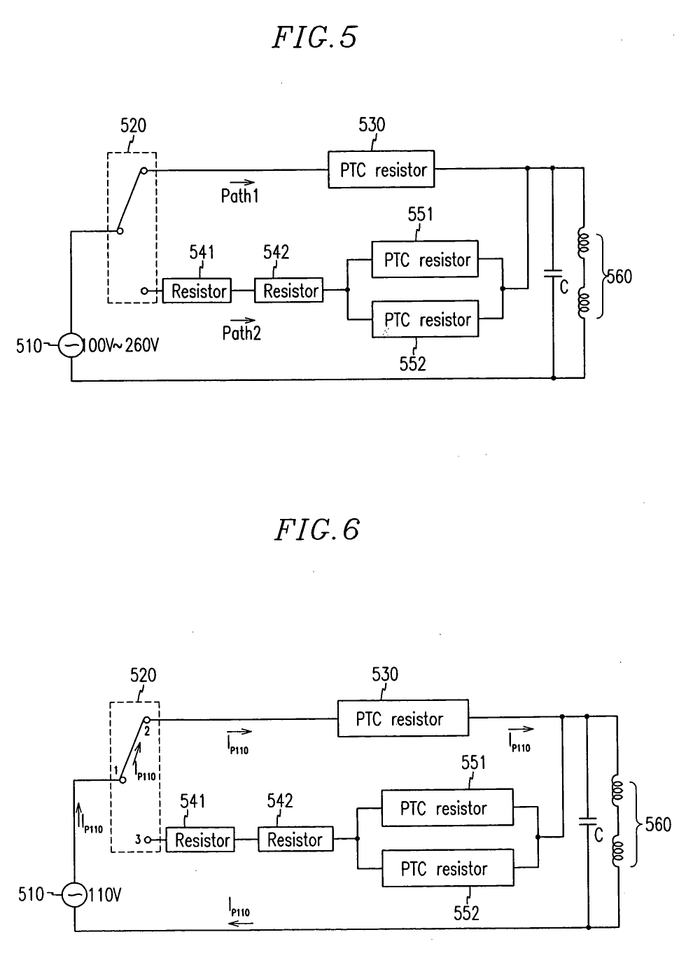

FIG. 3 is a flowchart describing an example of the application of the principles of the inventions to the control of blood pressure. The methodology approach is similar to that described with respect to FIG. 1. A subject's blood pressure is measured at step 302. Stimuli are presented to the subject at step 304. At step 306 the subject's blood pressure is measured. The measured blood pressure is compared at step 308 to the blood pressure measured at step 302. If the current blood pressure is higher than the previous blood pressure (either measured at step 302 or step 306) new stimuli are selected at step 312 and presented to the subject at step 304. Steps 304, 306, 308: and 312 form a continuous loop as long as the currently measured blood pressure is higher than the previously measured blood pressure. However, if the currently measured blood pressure is compared at step 308 and found not to be higher than the previously measured blood pressure, the same stimuli are selected at step 310 and again presented to the subject at step 304. Thus steps 304, 306, 308 and 310 form a continuous loop as long as the currently measured blood pressure is not higher than the previously measured blood pressure.

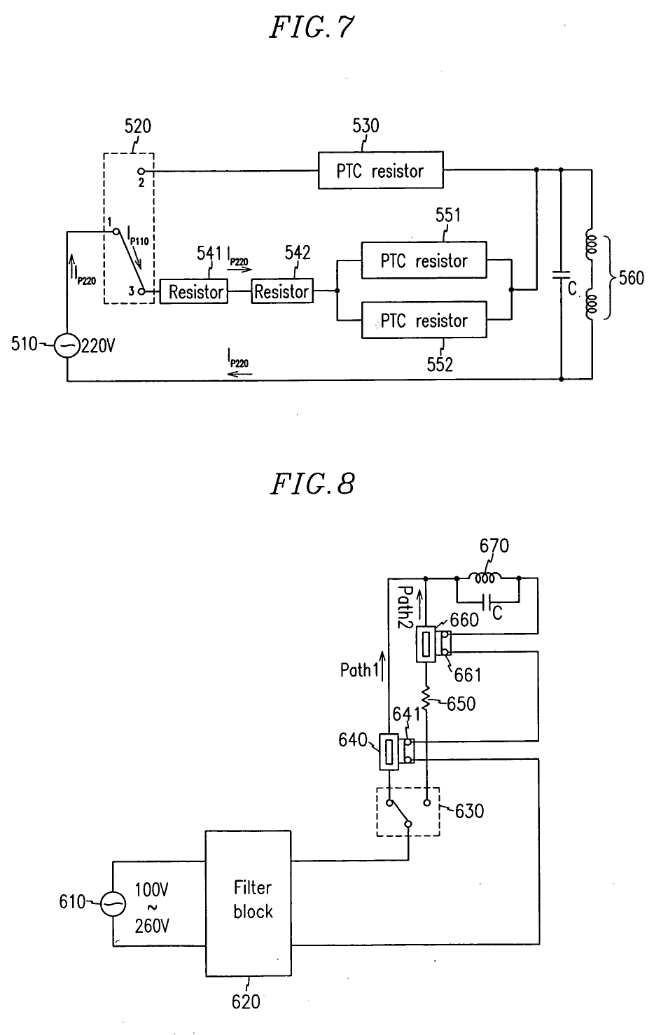

FIG. 4 is a flowchart describing an embodiment of the inventions relating to any general affect to be optimized. Again, the methodology is similar to that described with respect to FIG. 1. A human subject is measured via standard tests at step 402 to determine an affect on the subject. The subject is subjected, at step 404 to a first set of stimuli. The subject's affect is again measured by standard tests at step 406. At step 408 it is determined whether the affect of concern is worse than previous. If worse, new training stimuli are selected at step 410 and presented to the subject at step 404. Thus steps 404, 406, 408 and 410 form a continuous loop as long as the current affect is worse than the previous affect.

If, however, the current affect at step 408 is not worse than the previous affect, step 412 maintains the selected stimuli to be applied to the subject at step 404. Thus, steps 404, 406, 408 and 412 form a continuous loop as long as the current affect is not worse than the previous affect.

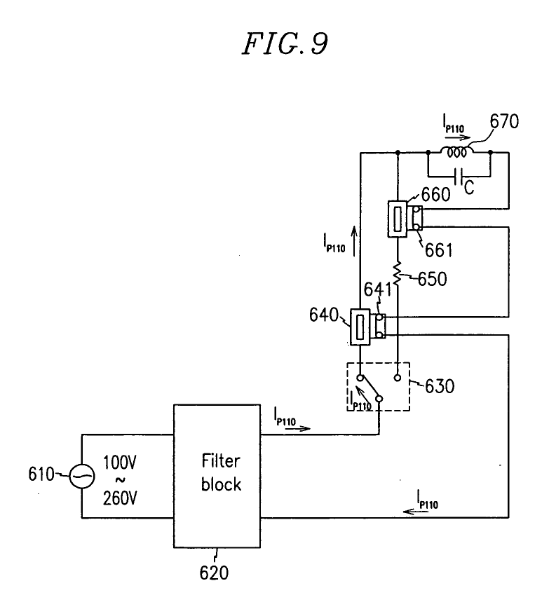

FIG. 5 is a flowchart of an embodiment of the inventions in which a group of subjects is tested in order to determine which stimuli are most useful in enhancing particular measures (e.g., blood pressure, performance). In general, the approach is similar to that described with respect to FIG. 2. The process begins at step 502 whereat multiple subjects are tested with respect to their ability to perform a task.

Each subject at step 504 is-subjected to stimuli in a looping fashion as described in FIG. 1. The subjects are relatively ranked at step 506 based on the number of trails required before achieving a given level of performance. It is noted at step 508 which stimuli were utilized on the highest ranking subjects as determined by step 506 and that stimuli is selected for presentation to additional subjects at step 510. In this manner the appropriate stimuli can be selected for training to enhance the particular measure, or to perform the particular task of concern.

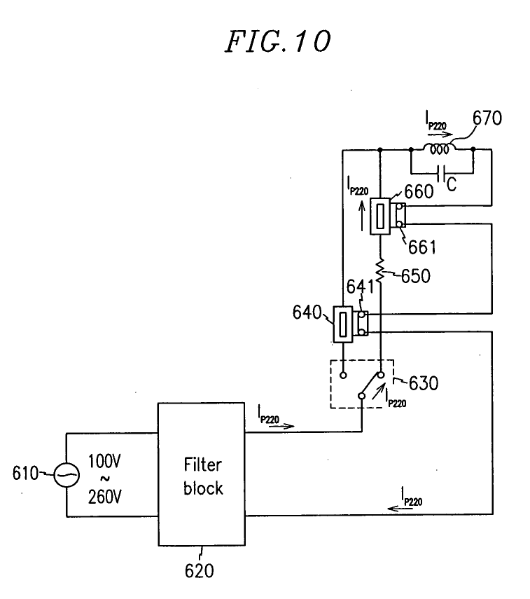

FIG. 6 is a flowchart of an embodiment of the inventions in which the principles of the invention are applied in order to determine the best stimuli to use on subjects to training them to perform a particular task. At step 602 multiple subjects are tested on a particular task. At step 604, each subject is subjected to training stimuli in a recursive fashion as generally described with respect to FIG. 1. At step 606 the stimuli are ranked based on the number of times they were used immediately, or soon, before trials in which improvement occurred. At step 608, rank-ordering continues. It is determined at step 610, when selecting new stimuli, to select from those with highest rank orderings as determined at steps 606 and 608.

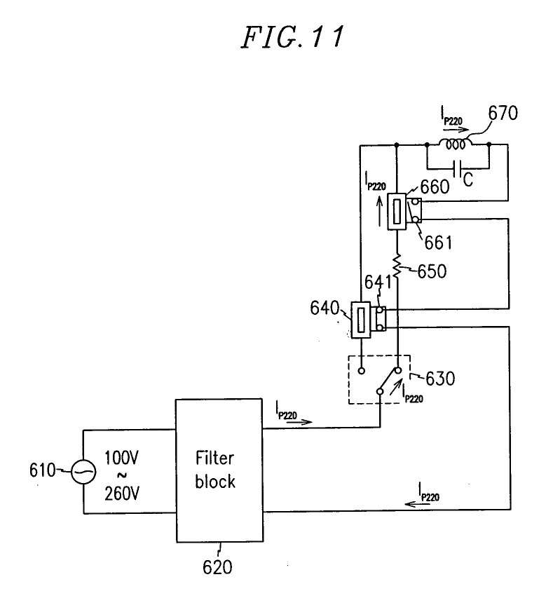

FIG. 7 is a flowchart of an embodiment of the inventions in which the principles of the invention are applied in order to determine the best stimuli to use on subjects to training them to perform a particular task. This embodiment is similar to the embodiment described above with respect to FIG. 6, except that new stimuli generated at the last step of the process are not just individual stimuli that have occurred before, but are combinations of previously utilized stimuli, selecting by rank order. At step 702 multiple subjects are tested on a particular task. At step 704, each subject is subjected to training stimuli in a recursive fashion as generally described with respect to FIG. 1. At step 706 the stimuli are ranked based on the number of times they were used before trials in which improvement occurred. At step 708, rank-ordering continues. It is determined at step 710, when selecting new stimuli, to select from those with highest rank orderings as determined at steps 706 and 708, but to generate new stimuli based on combinations of the higher ranking stimuli.

The above-described drawings and specific embodiments are only examples of the various applications of the principles of the inventions. Other examples of embodiments of the inventions include, but are not limited to, the following:

A multimodal (visual and/or auditory and/or tactile and/or olfactory and/or gustatory) presentation system used to improve performance of a subject, by means of presentation of stimuli, recording subjects' reactions to the stimuli, altering future stimuli in response to the subjects' reactions, and comparing changes in subject's reactions across trials, so as to:

improve the ability of a subject to store and retrieve information.

improve the number of memorized items recalled after a delay

increase the duration of delay during which a number of items can be recalled

improve the ability of a subject to select among a number of competing stimuli

improve the ability of a subject to track a moving item or items over time and space

improve measured ability to attend to a complex stimulus or multiple stimuli

improve the ability of a subject to withhold responses if desired

improve the ability of a subject to perform a complex series of prescribed motor tasks

improve the reading speed and comprehension of a subject

improve language recognition, including word pronunciation

alter the measured blood pressure of a subject

alter autonomic responses including but not limited to hunger, libido, fatigue

ameliorate subjective response to pain

improve subjective and/or measured affect and/or affective dysfunction

increase subjective sense and/or self-report of well-being or contentment.

The following is another example of the application of the principles of the inventions: Enhancement of pinnacle (asymptotic) performance in a task

In this example, the method involves repeated episodes in which a subject is first tested on the performance of a particular task, including but not limited to short term memory, selection of target among competing stimuli, tracking of a moving target, ability to withhold responses, motor skill and speed. Improvement in the task due to practice over multiple trials is measured. As the improvement asymptotes (i.e., as the rate of improvement decreases), episodes of the task will be alternated with various patterns of lights and tones. For those task episodes in which the individual performs better than statistically expected by the learning curve, features of the light and tone patterns that preceded the improvement will be stored, and will be successively incorporated into selected subsequent patterns. Combinations of features may be differentially tested in an automated pseudorandomized fashion so that differential contributions of different feature combinations are assessed for their association with either improved, lessened, or diminished performance on the task.

Another example of the applications of the principles of the inventions is accelerated ascent to pinnacle in a task. Here, the goal is to reach the asymptotic achievement level in the fewest possible trials. It is possible that feature combinations that lead to enhancement of asymptote, as above, will also lead to faster attainment of asymptote, or it may be that different stimulus presentations will achieve one versus the other.

Another example of the applications of the principles of the inventions is the accelerated ascent to enhanced pinnacle in a task. Here, we identify feature combinations that achieve both accelerated and enhanced measured asymptotic performance, regardless of whether distinct stimuli exist that differentially achieve one of these aims without the other.

Another example of the applications of the principles of the inventions is the accelerated ascent and/or enhancement of pinnacle in two or more tasks. Generally, the same adaptive methods described above are used to identify stimulus feature combinations that enhance (and/or accelerate the achievement of) asymptotic performance in two or more distinct behaviors.

Another example of the applications of the principles of the inventions relates to the lowering of blood pressure. We use the adaptive method to identify stimulus feature combinations that cause the subject's measured (systolic and/or diastolic) blood pressure to be lowered, and/or the reliable increase or decrease in the subject's measured heart rate.

Another example of the applications of the principles of the inventions relates to the altering of autonomic responses. Here, we use the method to identify stimulus feature combinations for the purposes including but limited to: increasing or decreasing the subject's self-reported feeling of hunger; increasing or decreasing the subject's self-reported libido; increasing or decreasing the subject's self-reported level of fatigue.

Another example of the applications of the principles of the inventions relates to altering a subject's subjective response to pain. We identify stimulus feature combinations for the purposes of increasing or decreasing the subject's self-reported feelings of pain.

Another example of the applications of the principles of the inventions relates to the altering of subjective affect. We identify stimulus feature combinations that alter a subject's self-reported affect.

Another example of the applications of the principles of the inventions relates to the improvement in tests of disorder. We identify stimulus feature combinations for the purpose of improving the subject's measured test scores on standard diagnostic tests including but not limited to depression, anxiety, affective disorders, obsessive compulsive disorder, schizophrenia, Tourette's syndrome.

The principles of the inventions described thus far can be used in combination with traditional drug therapies. We identify stimulus feature combinations for the purpose of increasing the effect of measured therapeutic effects (including but not limited to test scores on standard diagnostic tests for depression, anxiety, affective disorders, obsessive-compulsive disorder, schizophrenia, Tourette's syndrome), of specific prescribed or over-the-counter medications (including but not limited to antidepressants, anxiolytics, antipsychotics) in subjects taking those medications to alleviate a malady.

Another example of the applications of the principles of the inventions relates to the improvement of reading ability, speed, and/or comprehension via training. We use the adaptive method to identify stimulus feature combinations that cause measures of the subject's reading ability, speed, and/or comprehension to become improved over trials. The result may involve, but is not limited to, improvements in the subject's ability to recognize phonetic pronunciation.

An additional embodiment of the invention identifies stimulus feature combinations that continue to be effective after repeated use over trials, or continue to identify sequences of stimulus feature combinations that yield the intended effect during repeated use over trials.

We will now further discuss the induction of brain wave patterns associated with improved performance. In one set of embodiments of the inventions, the initial visual and auditory patterns used are selected from among those whose specific brain effects are at least partially known according to the published scientific literature. For instance, repetitive visual stimulation at a frequency rate of 10 Hz (10 instances per second) has been shown to induce “entrained” brain rhythms at about the same rate (which is in the range referred to as “alpha”) in certain brain areas, including early visual cortical areas in the occipital lobe.

Methods, such as those described above can be used to improve speed of response and/or accuracy of response, either i) under stress (e.g., interfering signals; threats), or ii) under duress (e.g., lack of sleep), or both. Such methods are of value not only while a subject is actively learning—but also the endpoints that it is able to reach after extended learning on one or multiple subjects. Such an endpoint can be used either as i) a starting point for a new subject or subjects, with continued learning, or ii) as a static system using the stimulus patterns that were previously learned by the system. This enables an initial system's learning to be used to generate multiple new useable systems that have immediate efficacy for users, either statically, without further learning, or with only moderate further learning.

There are various ways to implement the methods described above. For example, computer programs and computer media can be used (e.g., CPUs, fixed and removable storage) as means for providing software to computer systems. Computer programs can be used to enable a computer or related system to implement the principles of the inventions as discussed herein. Thus, the various “steps” described can be implemented in software that causes interaction with the subjects.

While various embodiments of the present invention have been described above, it should be understood that they have been presented by way of example, and not limitation. It will be apparent to persons skilled in the relevant art that various changes in detail can be made therein without departing from the spirit and scope of the invention. Thus the present invention should not be limited by any of the above-described exemplary embodiments.

1. A method for enhancing a skill of an individual, comprising:
determining a baseline performance level of the individual;
presenting first complex stimuli to the individual;
measuring the individual's reactions to the first stimuli and determining a second performance level;
presenting second complex stimuli that may be the same or different from the first complex stimuli based upon the individual's reactions.

2. A method according to claim 1, wherein the complex stimuli include auditory stimulation.

3. A method according to claim 1, wherein the complex stimuli include visual stimulation.

4. A method according to claim 1, wherein the complex stimuli include tactile stimulation.

5. A method according to claim 1, wherein the means for measurement includes means for measurement of reaction time.

6. A method according to claim 1, wherein the measuring includes measuring sensitivity.

7. A method according to claim 1, wherein the measuring includes measuring specificity.

8. A method according to claim 1 further comprising:
carrying out in an automated fashion an algorithm that selects the second complex stimuli so as to provide increased or decreased challenge level to the individual, as a function of the individual's current performance level.

9. A method according to claim 1, further comprising storing and utilizing performance levels attained by the individual to set initial values in the system when the particular individual begins a subsequent session.

10. A method according to claim 1, further comprising measuring baseline, improvement, and fatigue.

11. A method according to claim 1, wherein the individual's reaction comprises indicating a location on a display device.

12. A method according to claim 1, wherein future stimuli include extraneous signals that may distract the individual, including audio signals and/or visual signals.

13. A method according to claim 1, wherein the stimuli are selected so as to enhance the relative balance of activity in a set of at least two distinct brain areas.

14. A method according to claim 13 wherein the left anterior cortex is one of the brain areas to be balanced.

15. A method according to claim 14 wherein activity in left anterior cortex becomes increased.

16. A method according to claim 1 wherein the stimuli are altered via an algorithm for the extraction of statistically salient features.

17. A method according to claim 16 further comprising using a projection pursuit algorithm for the extraction of statistically salient features.

18. A method according to claim 16 wherein the extracting features comprises:
assigning a weight value for each feature in the presented stimulus;
incrementing weight values for those features in a stimulus presented before a performance improvement;
selecting subsequent stimulus feature combinations preferentially from those features with highest weight values.

19. A method according to claim 13 wherein particular brain areas are entrained to the range of the alpha rhythm.

20. A method according to claim 13 wherein particular brain areas are entrained to the range of the beta rhythm.

21. A method according to claim 13 wherein particular brain areas are entrained to the range of the theta rhythm.

22. A method according to claim 1 further comprising comparing the individual's reactions across trials.

23. A method according to claim 1 wherein the skill is the performance of a particular task and the method measurably enhances the performance of an individual performing the task.

24. A method according to claim 3 wherein the visual stimuli use various spectra (colors) of light to differentially stimulate the sympathetic and/or parasympathetic system.

25. A method for enhancing skills of a first group of subjects, comprising:
determining baseline performance levels of the subjects;
presenting first complex stimuli to the subjects;
measuring the subjects reactions to the first stimuli;
ranking the subjects based upon performance level achieved, determining second stimuli that were used by those subjects who achieved highest performance levels;
applying the second stimuli to subjects.

26. A method according to claim 25 wherein the subjects are those in the first group of subjects.

27. A method according to claim 25 wherein the subjects are among those in a second group of subjects different from the first group of subjects.

28. A method for enhancing skills of a first group of subjects, comprising:
determining baseline performance levels of the subjects;
presenting first complex stimuli to the subjects;
measuring the subjects reactions to the first stimuli;
ranking the subjects based on the number of trials needed to needed to achieve some (predetermined) criterion performance level, based upon performance level achieved,
determining second stimuli that were used by those subjects who achieved the predetermined performance level with the fewest number of trials needed;
applying the second stimuli to subjects.

29. A method according to claim 28 wherein the subjects are those in the first group of subjects.

30. A method according to claim 28 wherein the subjects are among those in a second group of subjects different from the first group of subjects.

31. A method for enhancing skills of a first group of subjects, comprising:
determining baseline performance levels of the subjects;
presenting multiple stimuli the subjects;
measuring the subjects reactions to the multiple stimuli;
ranking the stimuli based on the number of times each stimulus occurred immediately before an improvement was measured;
determining further stimuli based on the ranking of stimuli that most often induced enhanced performance;
applying the identified further stimuli to subjects.

32. A method according to claim 31 wherein the subjects are those in the first group of subjects.

33. A method according to claim 31 wherein the subjects are among those in a second group of subjects different from the first group of subjects.

34. A method according to claim 31 wherein the further stimuli are created as combinations of those stimuli that occurred most often before improvement was observed.

35. A method according to claim 31 wherein the newly created combination stimuli are applied to additional subjects.

36. A method for rank ordering subjects, comprising:
presenting multiple stimuli to a first group of subjects;
measuring the subjects reactions to the multiple stimuli;
ranking the stimuli based on the number of times each stimulus occurred immediately before an improvement was measured;
determining identified stimuli based on the ranking of stimuli that most often induced enhanced performance;
testing the performance of a second group of subjects using the identified stimuli; and
ranking the subjects based on their respective performances.

37. A method according to claim 36 wherein a subset of “most capable” subjects are identified by selecting only those subjects achieving a rank ordering above a determined threshold value.

38. A method for rank ordering subjects comprising:
subjecting multiple subjects to stimuli and testing their respective performance;
identifying a fixed sequential set of stimuli which resulted in the best performance;
presenting the fixed, sequential set of stimuli to subjects to be ranked; and
ranking the subjects according to the fewest trials required before achieving a criterion performance level.

39. A method according to claim 38 wherein a subset of “most capable” subjects is identified by selecting only those subjects achieving a rank ordering above a determined threshold value.
